(19) United States
(12) Patent Application Publication
(10) Pub. No.: US 2016/0061567 A1
(43) Pub. Date: Mar. 3, 2016

(54) ACCESSORY DISPLAY FOR OPTICAL SIGHTING DEVICES

(71) Applicant: Leupold & Stevens, Inc., Beaverton, OR (US)

(72) Inventors: Rick R. Regan, Aloha, OR (US); Richard Feinberg, Redmond, WA (US)

(21) Appl. No.: 14/839,884

(22) Filed: Aug. 28, 2015

Related U.S. Application Data
(60) Provisional application No. 62/043,780, filed on Aug. 29, 2014.

(51) Int. Cl. F41G 1/38; G02B 23/04; G02B 26/08; G02B 23/10

(52) U.S. Cl. CPC F41G 1/38; G02B 23/10; G02B 23/04; G02B 26/0816

(57) ABSTRACT

Optical aiming systems having a primary direct view optical system and an accessory optical system are arranged to provide a user with distinct views of a primary image and accessory image display without head movement. The primary optical system may be a riflescope and the accessory optical system may include an electronic image display device that directs light through a side wall of the riflescope toward an optical combiner or mirror within a housing of the riflescope. The optical combiner or mirror reflects the accessory display light through an eyepiece of the riflescope to form an exit pupil that is distinct from an exit pupil of the riflescope. The optical path of the accessory optical system may be angularly displaced relative to the optical path of the riflescope so that the accessory image display does not occlude aiming points within the field of view of the riflescope.

### RELATED APPLICATION

This application claims the benefit of priority under 35 U.S.C. § 119(e) of U.S. Provisional Application No. 62/043,780, filed Aug. 29, 2014, which is incorporated herein by reference.

### TECHNICAL FIELD

The present disclosure relates to optical sighting devices, such as riflescopes, for viewing distant targets or objects, and to methods and systems for visually presenting an accessory display or other auxiliary image in conjunction with a primary image of the optical sighting device.

### BACKGROUND

Optical sighting devices, such as binoculars, spotting scopes, telescopic sights, and riflescopes, typically include lenses and other optical elements supported within a housing that is sealed to prevent moisture and contamination from interfering with the optical performance of the device. Riflescopes are specialized telescopic sights that are mounted to a firearm and include a reticle or other aiming mark display for aiming the firearm. Riflescopes have eyepieces (aka oculars) designed for substantial eye-relief between the eyepiece and the user's eye—generally from 2 to 6 inches—to protect the user from injury when the firearm recoils. Pistol scopes are specialized riflescopes designed for use with pistols. Pistol scopes have longer eye relief than conventional riflescopes of the kind used with a rifle or carbine, allowing the pistol and pistol scope to be held at arm's length.

U.S. Pat. No. 6,295,754 of Otteman et al. describes a riflescope with a housing having exterior mounting features for attaching an auxiliary device, such as a thermal imaging device or range finder. A common tactical sight arrangement involves an auxiliary non-magnifying reflex sight mounted on top of such a riflescope. Because such auxiliary devices are mounted outboard of the riflescope housing a distance above or to the side of the riflescope optics, a user may need to move his or her head vertically or horizontally a significant distance to switch between the auxiliary device and the riflescope. Alternatively, the user may need to move the riflescope (and the weapon to which the riflescope is mounted) when alternating between viewing through the riflescope and viewing the auxiliary device. The significant amount of lateral or vertical head movement or riflescope/weapon movement required when transitioning between the riflescope and the auxiliary device could hinder a user's ability to quickly visually reacquire the target. Transitioning between viewing through the riflescope and viewing the display or image of an auxiliary device is yet more problematic when the eye relief distance of the auxiliary device is different from the eye relief of the riflescope.

It is known to combine an auxiliary imaging device with an optical riflescope and superpose the auxiliary image with the optical field, as shown for example in U.S. Pat. Nos. 3,699,341 of Quillinan et al., 5,035,472 of Hansen, 5,084,780 of Phillips, 5,497,266 of Owen, 5,745,287 of Sauter, and 6,111,692 of Sauter. These devices typically have primary and secondary optical paths that are merged and coaxially aligned before passing through the ocular lens. The present inventor has recognized that the superposed images in such devices can be confusing or distracting to the user. Furthermore, in some such systems, a failure of the auxiliary imaging device can disable the primary device (i.e., the riflescope) and vice versa.

There remains a need for an improved optical sighting system that facilitates the viewing of an auxiliary image or information display in addition to a principal image formed by a primary telescopic sight or other optical sighting device.

### SUMMARY

In one embodiment, an optical sighting device includes a first optical system, such as a riflescope, defining a first optical path and configured to form a first image viewable through an ocular of the first optical system. A second optical system defines a second optical path that extends through the same ocular, but that is non-coaxial with the first optical path so that it forms a second image offset from the first image and viewable through the shared ocular. The first and second optical systems preferably produce offset first and second exit pupils both viewable through the shared ocular. The second optical system may be adapted to form an image generated by an accessory device, such as a video camera, laser rangefinder, night vision sight, thermal imaging system, or an electronic display device, for example. In some embodiments the optical sighting device may comprise an optical combiner for combining the first and second optical paths for observation through the shared ocular. The optical combiner and the second optical system may be arranged relative to the first optical system so that the first and second optical paths diverge rearward of the ocular. In some embodiments, a small mirror is used in place of the optical beam combiner and placed near a focal plane at the edge of the field of view for combining the first and second optical paths for observation through the shared ocular. The mirror may be positioned at a rear focal plane of the first optical system near the exit pupil of the first optical system, so that the exit pupil of the first optical system at the rear focal plane is slightly overlapping with the second exit pupil of the second optical system, to present the accessory image at the periphery of the primary field of view of the scope. Alternatively, the second optical path and mirror may be positioned so that the second exit pupil is spaced apart from the first exit pupil, and comparably sized, allowing the user to switch between the primary and secondary images by eye movement, or in some embodiments by a very small head movement. The mirror or optical combiner may be selectively switchable between an active condition, extending into the first optical path, and an inactive condition, substantially removed from the first optical path.

In some embodiments, the exit pupil of the second optical system may not be a “true” exit pupil, but may instead be an “effective” exit pupil. In such embodiments, the eye relief for the “effective” exit pupil may be defined by where the user places his or her eye along the progression of collimated virtual image-forming rays from the display of the accessory device, in a similar fashion to viewing the red dot of a reflex sight. This may happen for optical systems, such as the embodiment illustrated in FIG. 12 or FIGS. 17-21, when there is no relay lens and the eyepiece is used as a magnifier.

The optical sighting device may include an elongate, generally tubular housing supporting the first optical system and the optical combiner or mirror between opposing first and second ends of the housing, with the first optical path extending longitudinally through the housing. In one embodiment, at least a portion of the second optical path extends through a hermetically sealed window in a side of the housing intermediate the first and second ends of the housing and adjacent the optical combiner or mirror. An exterior accessory mount may be provided for removably attaching and repeatably reattaching the accessory device at a fixed position relative to the first optical system and the window. In some embodiments, the optical sighting device further comprises an automatic bullet drop compensation subsystem operably coupled to at least one of the first optical system, the accessory device, and the second optical system.

In another embodiment, an accessory electronic display device is mounted to the outside of a primary optical sighting device such as a riflescope having a first optical system and first optical path. The accessory display device includes an electronic micro-display and collimating optics having an optical axis extending entirely outside of the eyepiece and angled relative to the first optical path so that the first and second optical paths converge to an eye point of the first optical system at an eye relief distance rearward of the eyepiece. From this eye point, a user can switch between the primary optical sighting device and the auxiliary display device merely by eye movement and without head movement or refocusing to a different distance.

Additional aspects will be apparent from the following detailed description of preferred embodiments, which proceeds with reference to the accompanying drawings.

### BRIEF DESCRIPTION OF THE DRAWINGS

FIG. 1 is a right side view of a riflescope in accordance with a first embodiment, shown mounted to an automatic rifle;

FIG. 2 is a left side elevation view of an optical sighting system including the riflescope of FIG. 1 and an accessory device mounted thereon;

FIG. 3 is an isometric view of the optical sighting system of FIG. 2;

FIG. 4 is an objective end view of the optical sighting system of FIG. 2;

FIG. 5 is an eyepiece end view of the optical sighting system of FIG. 2, with spaced apart first and second exit pupils illustrated;

FIG. 6 is an isometric view of the riflescope of FIG. 1 shown mounted to a rifle (only the barrel and receiver of the rifle are illustrated in FIG. 6), with the accessory device of FIGS. 2-5 omitted and a switching lever of the riflescope omitted from the left side of the eyepiece housing;

FIG. 7 is a cross section view of the riflescope of FIG. 1 taken along lines 7-7 of FIGS. 4 and 5, with the accessory device omitted;

FIG. 8 is a ray trace diagram showing a primary optical system of the riflescope of FIGS. 1-7, components of a second optical system, and an optical combiner;

FIG. 9 is a cross section view of an accessory device including an electronic micro-display, and with the optical combiner and ray traces of FIG. 8 shown schematically;

FIG. 10 is a schematic block diagram showing components of an automatic bullet drop compensation subsystem of the optical sighting system of FIGS. 2-5;

FIG. 11 is a pictorial side view of an optical sighting system according to another embodiment, including a riflescope and an accessory infrared camera and display device that injects a night vision video image into the eyepiece of the riflescope;

FIG. 12 is a schematic side elevation drawing showing the layout of the display device and a mirror positioned within the housing of the riflescope of FIG. 11;

FIG. 13 is a pictorial image of the optical sighting system of FIG. 11 from rearward of the eyepiece of the riflescope showing two distinct images including the riflescope exit pupil spaced apart from a night vision video image;

FIG. 14 is a pictorial side view of an optical sighting system according to an embodiment including a riflescope and an accessory laser rangefinding device and a display device that injects a ranging data readout display into the eyepiece of the riflescope;

FIG. 15 is a pictorial image of the optical sighting system of FIG. 11 from rearward of the eyepiece of the riflescope showing the riflescope exit pupil and the ranging display readout display offset from the exit pupil;

FIG. 16 is a pictorial representation of a possible display of the optical sighting system of FIG. 14, wherein the ranging data readout display overlaps with the exit pupil of the riflescope and is superposed on the field of view of the riflescope;

FIG. 17 is an annotated side elevation pictorial view of a prototype riflescope and retrofittable accessory image display device for monocular viewing according to yet another embodiment;

FIG. 18 is an annotated top pictorial view of a prototype riflescope and retrofittable accessory image display device for binocular viewing according to still another embodiment;

FIG. 19 is a side elevation pictorial view of another prototype riflescope and retrofittable accessory image display device for monocular viewing similar to the embodiment of FIG. 17;

FIG. 20 is an enlarged side elevation view of the eyepiece end portion of the riflescope and accessory image display device of FIG. 19; and

FIG. 21 is a view of the image displays of the riflescope and accessory image display device of FIG. 19, as seen from a common eye point rearward of the eyepiece.

### DETAILED DESCRIPTION OF PREFERRED EMBODIMENTS

This section describes particular embodiments and their detailed construction and operation. The embodiments described herein are set forth by way of illustration only and not limitation. Throughout the specification, reference to “one embodiment,” “an embodiment,” or “some embodiments” are not necessarily all referring to the same embodiment. The described features, structures, characteristics, and methods of operation may be practiced in isolation or combined in any suitable manner, and can be practiced without one or more of the specific details or with other methods, components, materials, or the like. In other instances, well-known structures, materials, or methods of operation are not shown or not described in detail to avoid obscuring more pertinent aspects of the embodiments.

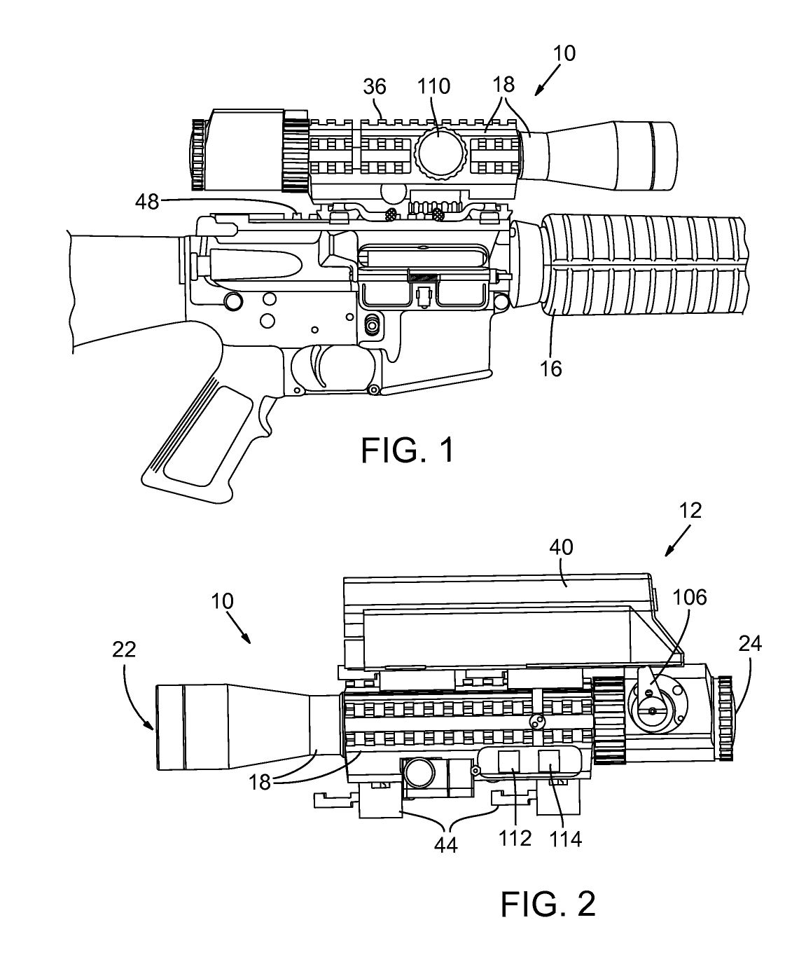

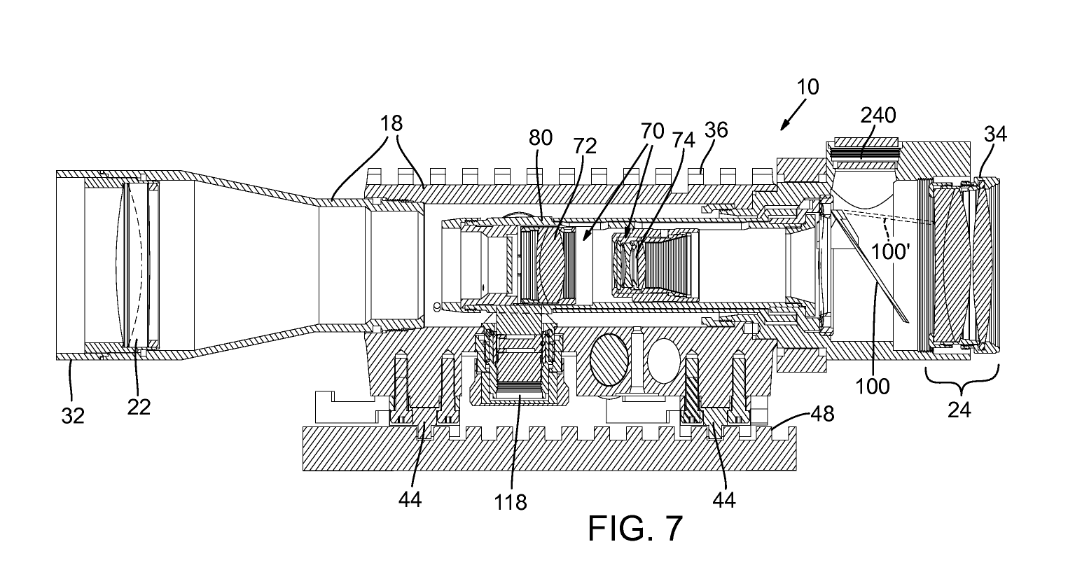

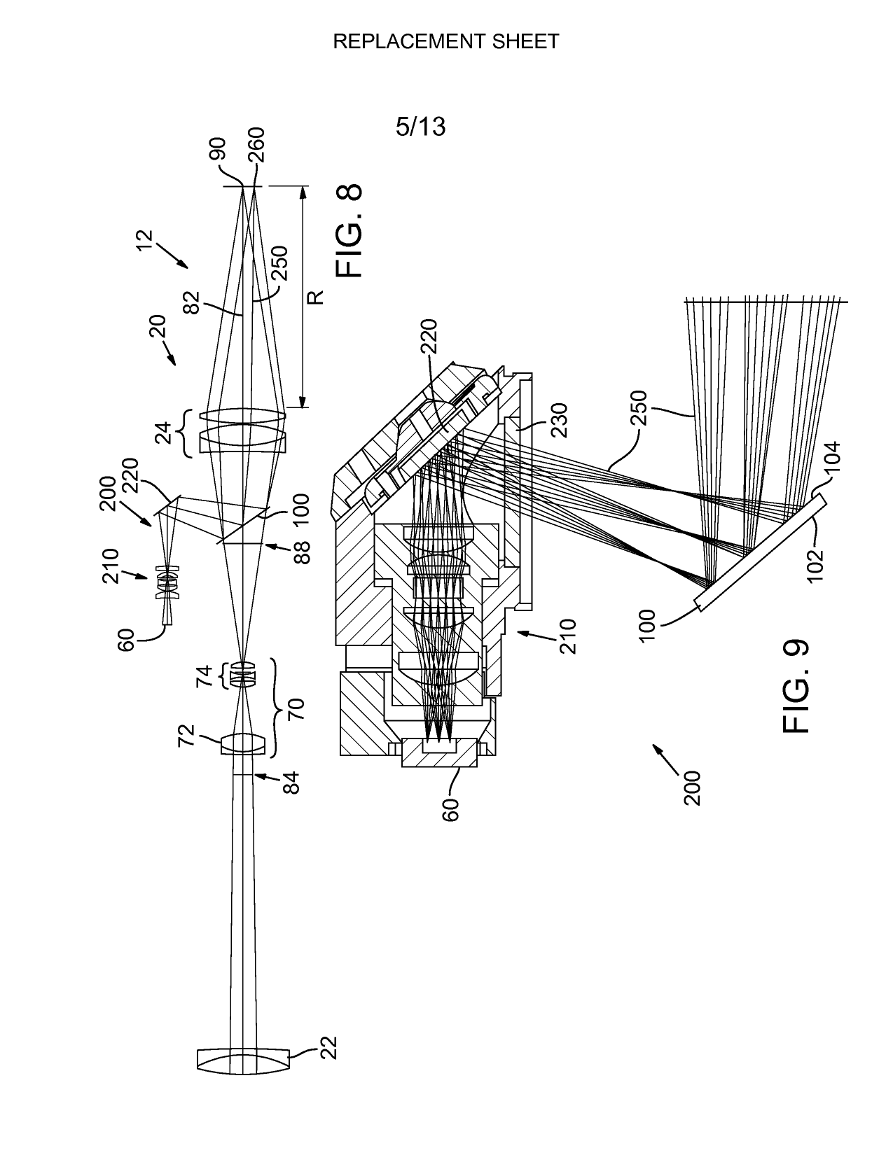

FIG. 1 is a right side view of a riflescope 10 shown mounted to an automatic rifle 16 in accordance with a first embodiment of an optical sighting device (optical sighting system 12 illustrated in FIGS. 2-5). With reference to FIG. 1, riflescope 10 comprises an elongate housing 18 supporting a first optical system 20 (FIGS. 7 and 8) including an objective 22 and an ocular (eyepiece) 24 at opposing forward and rearward ends 32, 34 of housing 18. Housing 18 preferably includes a mounting base 36 formed along its exterior surface for mounting an accessory device 40 (FIG. 2) to riflescope 10 to form the combination optical sighting system 12 (optical sighting device) illustrated in FIGS. 2-5. Accessory mounting base 36 may be a Picatinny rail (MIL-STD-1913) or Weaver rail formed integrally in housing 18, as disclosed in U.S. Pat. No. 6,295,754 of Otteman, or accessory rails rigidly attached to housing 18 by way of screws, clamp rings, or otherwise. Accessory device 40 is preferably removably mountable to mounting base 36, although in other embodiments (not shown) accessory device 40 may be mounted to a smooth housing via clamp rings, sleeves, or other external adapters, as illustrated in FIGS. 11 and 17-20, or may be an auxiliary display device integrated with riflescope 10 in a common housing.

With reference to FIG. 2, riflescope 10 may include an integrated mounting clamp system 44, for removably attaching riflescope 10 to a primary mounting rail 48 (FIG. 1) located along the top of the receiver of rifle 16 or in another location on a weapon.

Accessory device 40, illustrated in FIGS. 2-4, may be any of a variety of devices capable of producing an image via an electronic display or otherwise, for injection of image-carrying light into riflescope 10 for viewing via the shared ocular 24, as further described below. For example, accessory device 40, in the embodiment shown, is a laser rangefinder system having separate lenses 52, 54 (FIG. 4) for the laser transmitter and receiver and having a display device 60 (FIGS. 8 and 9) such as an LED, LCD, or OLED device that displays range data calculated by the laser rangefinder. Accessory device 40 may alternatively include one or more of a night vision system such as an image intensifier or thermal imaging system, a mapping display, a battlefield awareness system, a text information display, a graphical or stored image display, a digital camera, and a video camera. Accessory device 40 may include communications capability via wired or wireless connection to a separate device, such as a spotting scope or rangefinder operated by a spotter in a shooter-spotter team, as discussed in U.S. Pat. No. 7,654,029 of Peters et al., which is incorporated herein by reference. In one embodiment, data may be received by accessory device 40 via wireless communication using a radio (not illustrated) in the accessory device 40, operating on any of a variety of short or long-distance communications technologies, such as Bluetooth, WiFi, mobile telephone communications technologies, or others. Accessory device may also include mapping functionality and a GPS receiver for presenting a map display optionally overlaying personal location information, and optionally the location of friendly forces based on such data received via radio-frequency data communication. In another embodiment, data communication and auxiliary display capabilities may be integrated into riflescope 10.

With reference to FIGS. 7 and 8, first optical system 20 further includes an erector lens system 70 which may include first and second movable erector lens groups 72, 74 mounted in a pivot tube 80 that is pivotably movable within housing 18 to effect windage and elevation aiming adjustments. Erector lens groups 72, 74 may be longitudinally movable along the pivot tube 80 to adjust an optical power (magnification) of the riflescope 10 while maintaining focus. In other embodiments, erector lens system 70 may be a fixed power system. In still other embodiments, erector lens system may be replaced by a prism erector system. First optical system 20 defines a first optical path 82 along which an image of a distant target is formed at a focal plane. In the embodiment illustrated, a first inverted image is formed at a front focal plane 84 located between objective 22 and erector lens system 70. Erector lens system 70 relays and erects the first inverted image to form an upright second image at a rear focal plane 88 generally located between erector lens system 70 and eyepiece 24. The upright second image is then magnified by and viewed via eyepiece 24 from a first eye point 90 located an eye relief distance R rearward of eyepiece 24. First optical system 20 forms a first exit pupil 94 (FIG. 5) viewable through eyepiece 24.

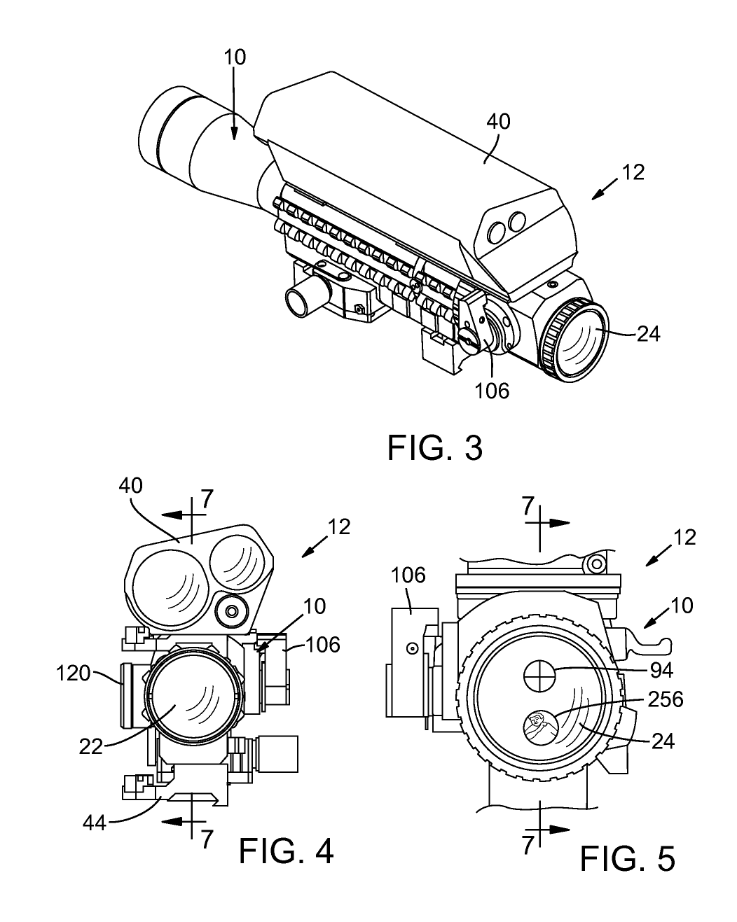

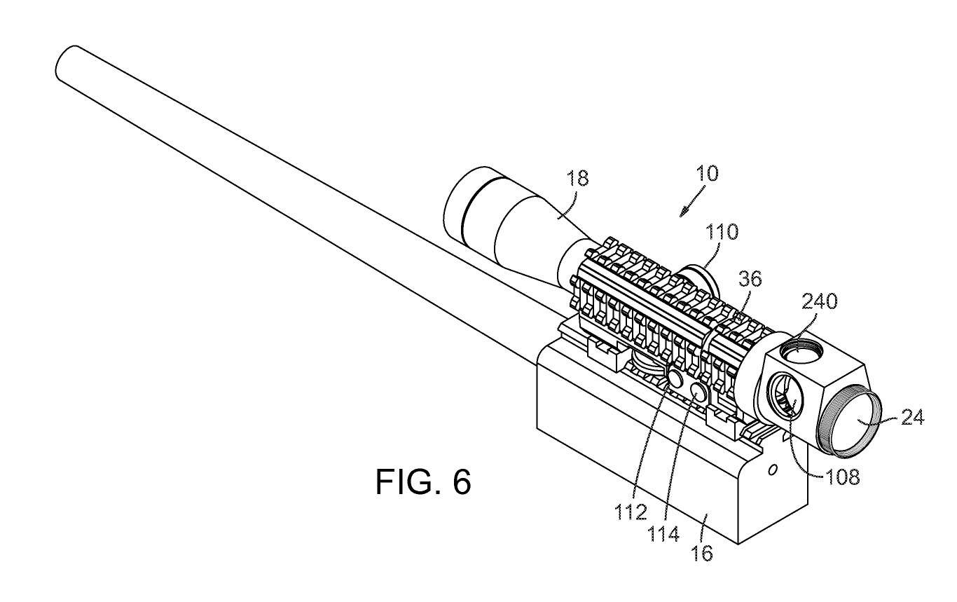

In the embodiment illustrated in FIGS. 1-9, an optical combiner 100, such as a prism beam combiner, pellicle, half-silvered mirror, fiber beam combiner, dichroic mirror, or other partially reflective surface, is located within housing 18 preferably in first optical path 82 between rear focal plane 88 and eyepiece 24, but may optionally be located elsewhere in first optical path 82. Optical combiner 100 transmits to eyepiece 24 at least a portion of the light of first optical system 20 incident on a first surface 102 of the optical combiner 100. A second surface 104 of optical combiner 100 rearwardly reflects (toward eyepiece 24) at least a portion of light that is directed toward second surface 104 by a second optical system 200, described below with reference to FIGS. 8 and 9. Optical combiner 100 may be a passive optical device, such as the pellicle, fiber beam combiner, or may be an active device, such as an LCD-type device, that is electronically switchable. Either way, optical combiner 100 may be mounted on a hinged or rotating mount allowing optical combiner 100 to be moved out of the way of first optical path 82, for example, to a second position 100′ illustrated in dashed lines in FIG. 7. Optical combiner 100 may be moved using a manual switching lever 106 (FIGS. 2 and 3) coupled to optical combiner 100 via a left-side port 108 (FIG. 6) in housing 18, or in another manner. Thus, optical combiner 100 can be removed from the primary optical path to allow the best possible image of first optical system 20 to be viewed when the auxiliary display of second optical system 200 is not needed or desired. In other embodiments (not illustrated), the optical combiner may be switched off electronically or moved out of the first optical path in another manner other than by switching lever 106.

With reference to FIGS. 2, 6, and 7, riflescope 10 may include a motorized elevation adjustment mechanism including pushbutton switch controls 112, 114 that activate a motorized screw 118 or other linear adjustment mechanism to effect respective upward and downward pivoting movement of pivot tube 80 and the erector lens assembly 70 to achieve a desired elevation adjustment. Similarly, horizontal (windage) adjustment of pivot tube 80 is accomplished by an adjustment knob 120 (FIGS. 1, 4, and 6), which may be fully manual or motorized.

FIG. 8 is a ray trace diagram showing a primary optical system of the riflescope of FIGS. 1-7. It should be understood that the ray trace diagram of FIG. 8 locates the pupils of the primary optical system, unlike a conventional ray trace diagram which locates the image planes of the system. With reference now to FIGS. 7 and 8, a second optical system 200 includes an image-forming optical device such as display device 60, a relay lens system 210, a mirror 220, and an exit window 230. When auxiliary device 40 is mounted to riflescope 10, light from second optical system 200 is directed through a transparent entrance window 240 in housing 18 and reflected by optical combiner 100 to allow a user to view a relayed image of display device 60 via eyepiece 24. Second optical system 200 and optical combiner 100 define a folded second optical path 250 that extends through eyepiece 24, but may preferably be non-coaxial with first optical path 82, as best illustrated in FIG. 8, so that second optical system 200 produces a second exit pupil 256 (FIG. 5) viewable through eyepiece 24 as being distinct from first exit pupil 94 of first optical system 20. The portion of second optical path 250 extending through eyepiece 24 is preferably angularly displaced relative to the first optical path 82 as the two optical paths pass through the shared eyepiece 24, as best illustrated in FIG. 8. The first and second optical paths 82, 250 diverge rearward of the eyepiece 24 as long as their respective exit pupils are not coincident. Second optical system 200 preferably forms an image at a location near rear focal plane 88 that is spatially offset from the location on rear focal plane 88 at which the first optical system 20 forms an erect image. The image formed by the relay lens system 210 of second optical system 200 may be formed at an image plane (not illustrated) that is angularly displaced relative to rear focal plane 88 by an angle of 90 degrees plus the same angle by which the first and second optical paths 82, 250 are angularly displaced.

By producing two distinct exit pupils, optical sighting system 12 enables the user to switch alternatingly between viewing the image of first optical system 20 and the image of second optical system 200 (i.e., to view first and second viewing channels) with only a very small head movement, or without any head movement by merely rotating the user's eye in its socket. In some embodiments, the optical systems 20, 200 may be arranged so that the first and second viewing channels overlap, causing all or a portion of the image produced by second optical system 200 to overlap the image produced by first optical system 20 near the periphery of the image of the first optical system 20. In other embodiments the first and second exit pupils 94, 256 may be spaced apart such that a second eye point 260 from which the second channel is viewed, is vertically spaced apart from first eye point 90. In still other embodiments, the first and second exit pupils may be concentric (i.e. not offset) so that the image of the second optical system is fully superposed on the image of the first optical system, in which case the first and second optical paths 82 and 250 would be substantially coincident (not illustrated) at the eyepiece 24 and eye points 92, 260.

Second surface 104 of optical combiner 100 may be inclined between approximately 30 degrees and approximately 44 degrees relative to an optical axis of eyepiece 24, or between approximately 46 degrees and approximately 60 degrees, or at approximately 45 degrees, or between approximately 30 and 60 degrees. More preferably, second surface 104 of optical combiner 100 is inclined between approximately 40 degrees and approximately 44 degrees, or between approximately 46 degrees and approximately 50 degrees.

Both the exit window 230 and the entrance window 240 may be hermetically sealed to inhibit moisture and contamination from entering accessory device 40 and riflescope 10, respectively, thereby preventing fogging and image degradation. Riflescope 10 and accessory device 40 may both be filled with a dry gas such as nitrogen to prevent condensation from forming on internal lens and window surfaces when the devices are exposed to cold weather.

In the embodiment illustrated in FIGS. 2-8, entrance window 240 and optical combiner 100 are positioned near rear focal plane 88, to allow second optical path 250 to be injected between erector system 70 and eyepiece 24. However, in other embodiments (not illustrated), the entrance window 240 and optical combiner 100 may be located near front focal plane 84, or at another location in riflescope 10.

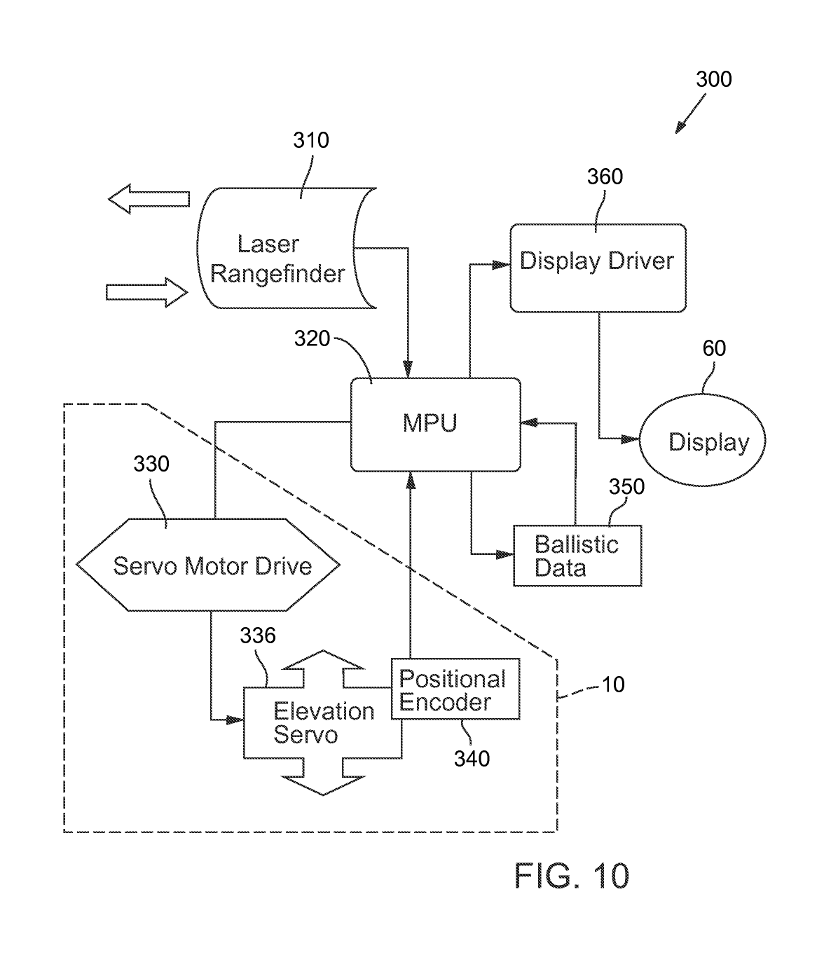

FIG. 10 illustrates an automatic ranging and ballistic adjustment system 300 that could be implemented in the riflescope 10 and accessory device 40 of FIGS. 1-9. With reference to FIG. 10, a laser rangefinder 310 is coupled to a microprocessor unit (MPU) 320. Laser rangefinder 310 determines a range to a distant target and provides the range data to MPU 320. Laser rangefinder 310 may also include an inclinometer for determining an angle of inclination of a line of sight to the target, and other sensors measuring variables affecting ballistics. MPU controls a servo motor drive 330 which moves an elevation servo device 336 such as motorized screw 118 (FIG. 7). A positional encoder 340 associated with servo device 336 senses the position of the elevation servo device 336 and provides accurate positional feedback data to MPU 320, allowing MPU 320 to accurately determine the elevation adjustment of riflescope 10 and accurately control servo 336 via motor drive 300. MPU 320 is also coupled to a memory 350 for accessing ballistic data stored thereon. A user interface or electronic data interface (not shown) may be provided for inputting ballistic data into memory 350 or selecting from one of several ballistic profiles or sets of ballistic data stored in memory 350. Utilizing the measured distance and other information determined by laser rangefinder 310 along with the ballistic data retrieved from memory 350, MPU 320 calculates a ballistic adjustment or other ballistic solution for aiming a projectile at the distant target, then produces a display via display driver 360 that is displayed on display device 60 for viewing via eyepiece 24. In some embodiments, the display produced by ballistic adjustment system 300 may be an information display at the edge of or just outside of the field of view of the target scene. In other embodiments, an image produced by display 60 may be superimposed on the first image of the first optical system 20 to provide a ballistically adjusted aiming point overlaid with the target scene.

Other aspects of riflescope 10 and accessory device are described in the Exemplary Features section below.

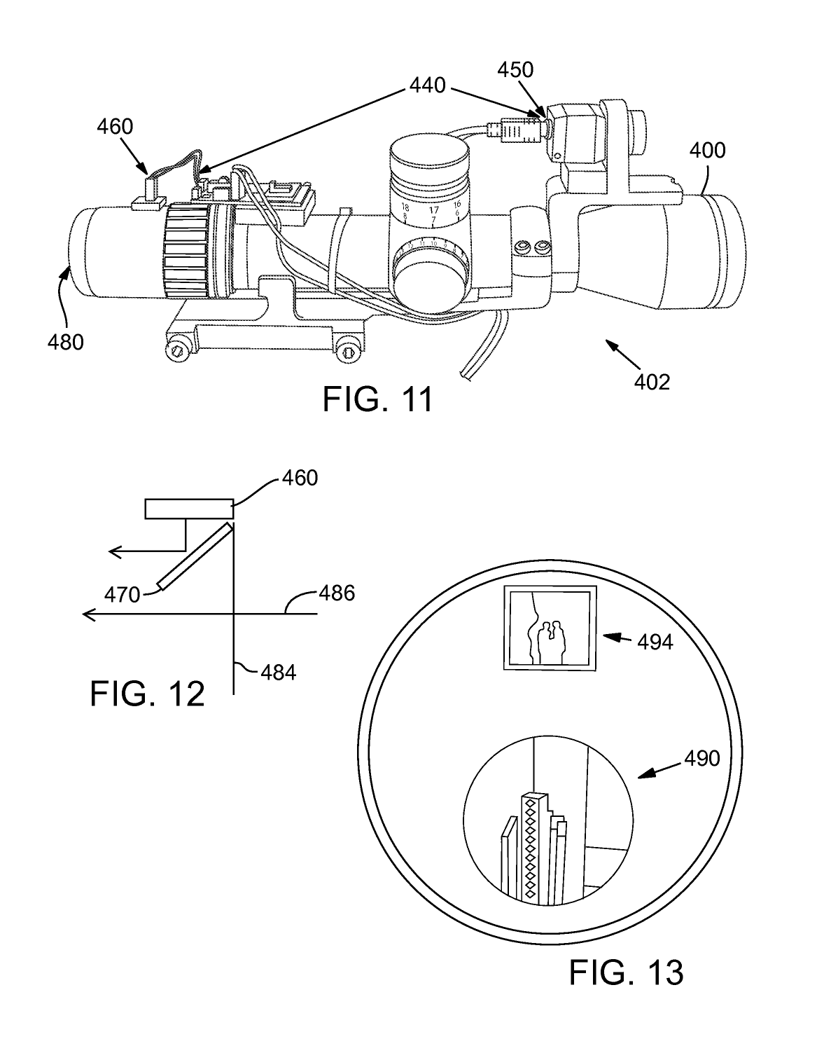

Turning now to FIG. 11, a riflescope 400 and an auxiliary device 440 form an optical sighting system 402 according to another embodiment. Auxiliary device 440 includes a miniature night vision camera, such as a FLIR Quark™ infrared imaging device 450, mounted to riflescope 400 facing forward toward a target scene, and a miniature electronic display device 460 in communication with the infrared imaging device and mounted horizontally over a window or aperture in the side of a housing of riflescope 400. A small mirror 470, illustrated schematically in FIG. 12, is located within riflescope 400 and below electronic display 460 so as to reflect light emitted from display 460 and redirect it toward an eyepiece 480 of riflescope 400. By locating the electronic display device 460 and mirror 470 immediately adjacent the rear focal plane 484 of riflescope 400, the auxiliary device 440 may avoid the need for expensive reimaging optics such as relay lens system 210 of the system of FIGS. 1-9.

Mirror 470 is preferably smaller than the image generated by riflescope 400 at the rear focal plane 484 and spaced apart from the optical axis 486 of riflescope 400 so that the image generated by display device 460 and reflected by mirror 470 is spaced apart from the image of the field of view of riflescope 400. Thus, the image of display device 460 as viewed through eyepiece 480 may be spaced apart from the exit pupil of the primary optical system of riflescope 400. The images generated by riflescope 400 and display device 460 may both be viewed from a common head position and common eye point, merely by rotating the user's eye in its socket. The direct view optics of riflescope 400 are unimpeded by mirror 470 so that there is no reduction in light transmission or color shift. In other embodiments (not illustrated), the image of display device 460 relayed by mirror 470 is overlapping or superposed on the image of the field of view of riflescope 400 while being distinct and not obstructing aiming points of a reticle of riflescope 400. FIG. 13 illustrates a view through eyepiece 480 of riflescope 400, showing both an exit pupil 490 of the direct view optics of riflescope 400 and an auxiliary image 494 generated by the infrared imaging device 450 and displayed via display device 460 and reflected by mirror 470 (itself forming an exit pupil), so as to appear spaced above exit pupil 490.

Infrared imaging device 450 and display device 460 are shown integrated with optical sighting system 402, but may alternatively be detachably mounted to housing 418 of riflescope 400, with display device 460 mounted adjacent a transparent window in the side wall of housing 418 as in the embodiment of FIGS. 1-9. Also, although a thermal image from the FLIR Quark device 450 is illustrated in FIG. 13, any other kind of still or video image may be displayed via display device 460, similarly to the embodiment of FIGS. 1-9. Displayed video can be of a different magnification than that of riflescope. In one embodiment, a sensor (not illustrated) may be associated with a manually adjustable optical power setting of riflescope 400 to sense the optical power setting (magnification) of riflescope 400. Auxiliary device 440 may receive signals from the sensor and adjust a magnification of the auxiliary image in response to and/or in coordination with the optical power setting of riflescope 400.

Mirror 470 may be mounted to a hinge or other movable mounting structure that allows mirror 470 to be flipped between the active position shown, wherein mirror 470 is inclined approximately 45 degrees relative to the optical axis 486, and an inactive position out of the primary optical path of riflescope 400—for example, in which the mirror is flipped up or rotated about its top edge to a horizontal orientation (not shown) closely adjacent and covering display device 460. In some embodiments, the active position may be between 40 degrees and 50 degrees relative to the optical axis 486 and the inactive position may be parallel to the optical axis 486 (0 degrees).

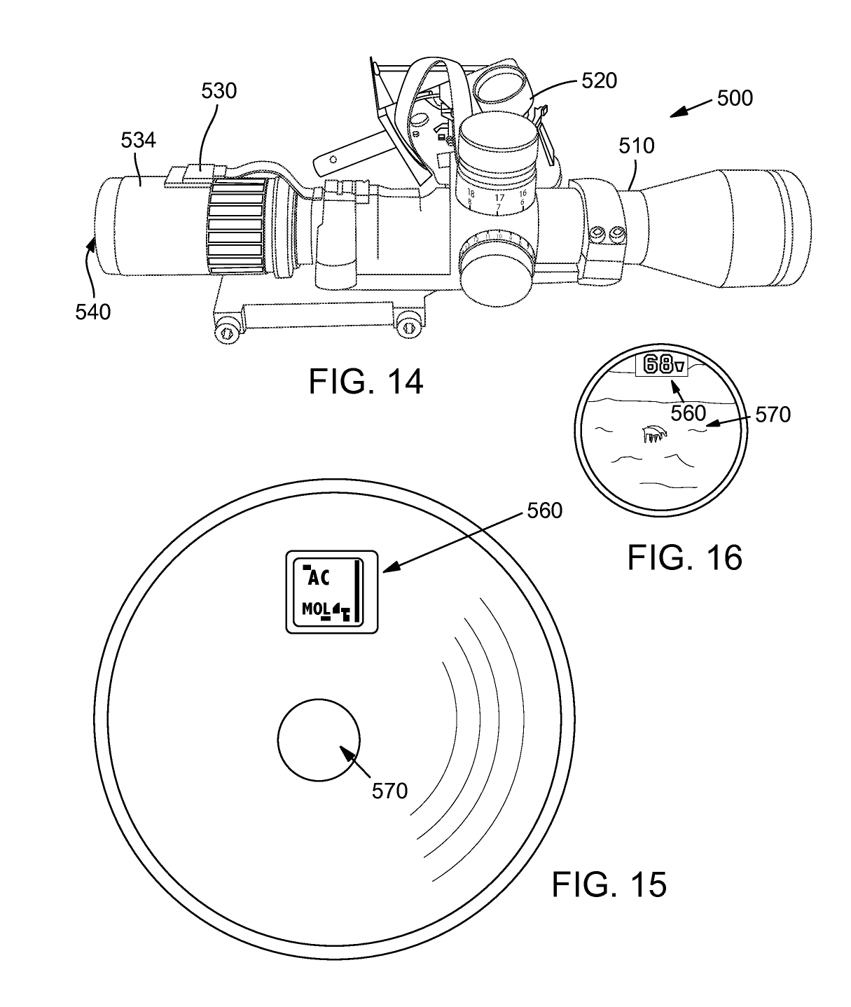

FIG. 14 illustrates an embodiment of an optical sighting system 500 including a riflescope 510 similar to riflescope 400 of the embodiment of FIG. 11. In this embodiment, the auxiliary device is a laser rangefinder module 520, which may be supported on and aligned with riflescope 510 or handheld separately from riflescope 510, for example by a spotter. A rangefinder data readout is presented on an OLED display unit 530 mounted on housing adjacent a window or opening (not shown) in a housing 534 of riflescope 510 adjacent its eyepiece 540. As in the embodiment of FIGS. 11-13, a mirror (not illustrated) is provided within housing 534 near the rear focal plane of riflescope 510 for reflecting light from display unit 530 through eyepiece 540 to provide the auxiliary device information display 560 shown in FIG. 15, spaced apart from or adjacent an exit pupil 570 of riflescope 510. FIG. 16 illustrates that auxiliary information display 560 may be positioned (by virtue of the position of the mirror and display unit 530) so as to overlap and occlude a portion of the field of view of riflescope 510. As in the embodiment of FIGS. 11-13, the mirror may be selectively removable from the field of view by the user, such as by a mechanical or electromechanical actuation to flip the mirror out (and back into) the field of view, or by electronically changing the reflective properties of an electronically controllable mirror.

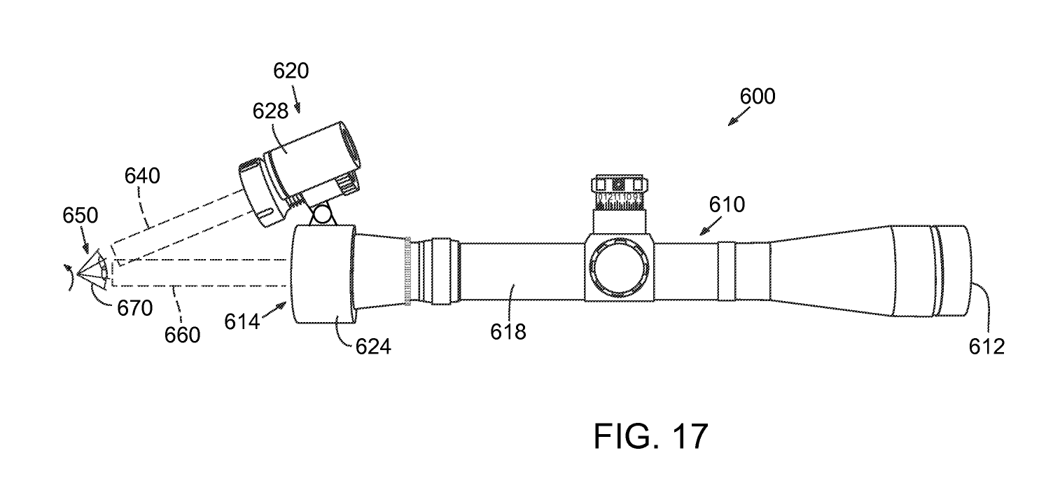

FIG. 17 is an annotated side elevation pictorial view of another embodiment of an optical sighting system 600 including a riflescope 610 and retrofittable accessory image display device 620 for monocular viewing. With reference to FIG. 17, riflescope 610 may be of a conventional design, including an objective 612 and an eyepiece 614 at opposite ends of a housing 618 of riflescope 610. Accessory image display device 620 includes a mount 624 that is attachable to riflescope 610, for example by sliding or threading onto the eyepiece end of housing 618. A display housing 628 may be connected to mount 624 via a hinge (not shown) allowing an angle of display housing accessory image display device 620 to be adjusted relative to the optical axis of riflescope 610. Although not illustrated in FIG. 17, display housing 628 contains an electronic display device and display electronics. Display housing 628 may contain collimation optics with a manual diopter adjustment, a power source, and a radio-frequency receiver that receives a video or data signal wirelessly from a remote source of data or video. Alternatively, a video or data feed may be received by image display device 620 via a wired connection, such as a USB connection for example.

Accessory image display device 620 preferably generates an accessory display channel 640 viewable from a common eye point 650 whereat a primary optical channel 660 of riflescope 610 is also viewable without requiring head movement. A user may switch between primary and accessory channels 660, 640 merely by rotating the user's eye 670 in its socket and without any substantial movement of the user's head.

When using riflescope 610, a shooter would normally place his eye 670 at the eye point 650 of riflescope 610, which is located approximately 2-6 inches (and more typically 3-4 inches) rearward of eyepiece 614. The display housing 628 of accessory image display device 620 is mounted above or to the side of the last (rearward) lens element of eyepiece 614. An output beam from the accessory display device 620 is adjustable for aiming at the eye point 650 by means of the hinged mounting connection between display housing 628 and mount 624. In the embodiment illustrated, accessory image display device 620 is retrofittable on riflescope 610 and easily installed and removed in the field when needed. In another embodiment (not illustrated), accessory image display device 620 could be integrated into riflescope 610 and contained within the housing 618 of riflescope 610.

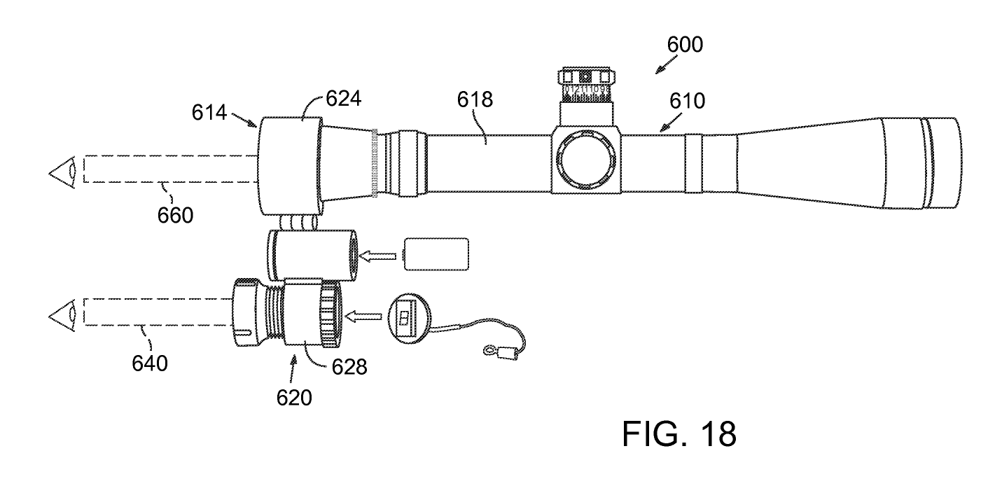

FIG. 18 illustrates optical sighting system 600 with riflescope 610 and accessory image display device 620 configured in a binocular mode. With reference to FIG. 18, display housing 628 is rotated relative to the binocular hinge (not shown) to the binocular viewing position, in which display housing 628 and the video/image display and collimation optics contained within it are aligned parallel to the optical axis of the optical viewing channel 660 of riflescope 610. The display housing may also be rotated around its own viewing axis to substantially align the horizontal and vertical aspects of its image to the horizontal and vertical aspects of the scope's image. In the binocular viewing position illustrated, the accessory display channel 640 of the accessory image display device 620 is aligned with the optical viewing channel 660 of riflescope 610. The accessory display channel 640 is spaced apart to the side of the optical viewing channel 660 by an interpupillary distance that is adjustable by rotating display housing 628 about the hinge in substantially the same manner as a hinged bridge of conventional binoculars. In the binocular viewing configuration of FIG. 18, the images of the riflescope 610 and auxiliary display device 620 are viewed by different eyes and fused by the user's vision. The hinge arrangement is adaptable for left-handed and right-handed shooters by twisting the mount 624 about the eyepiece 614 of riflescope 610 to position the hinge either to the left or right side of eyepiece 614.

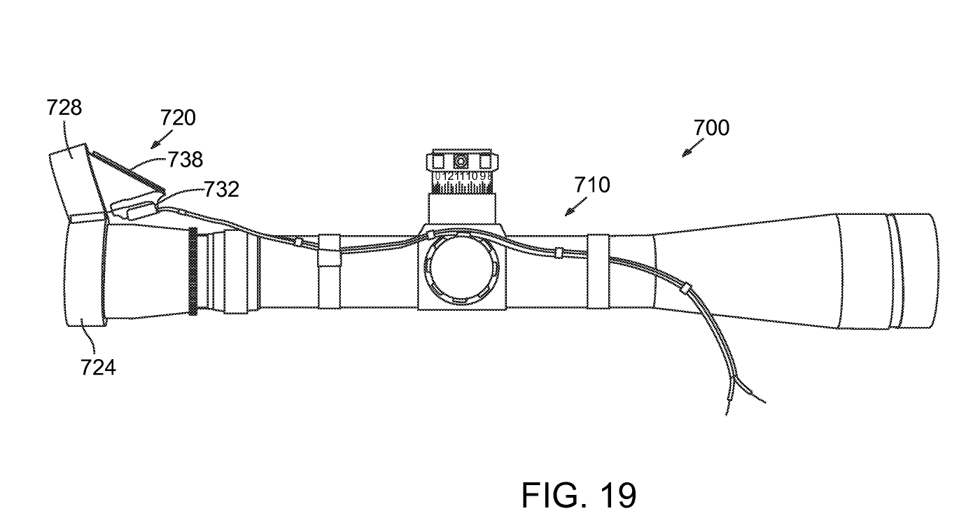

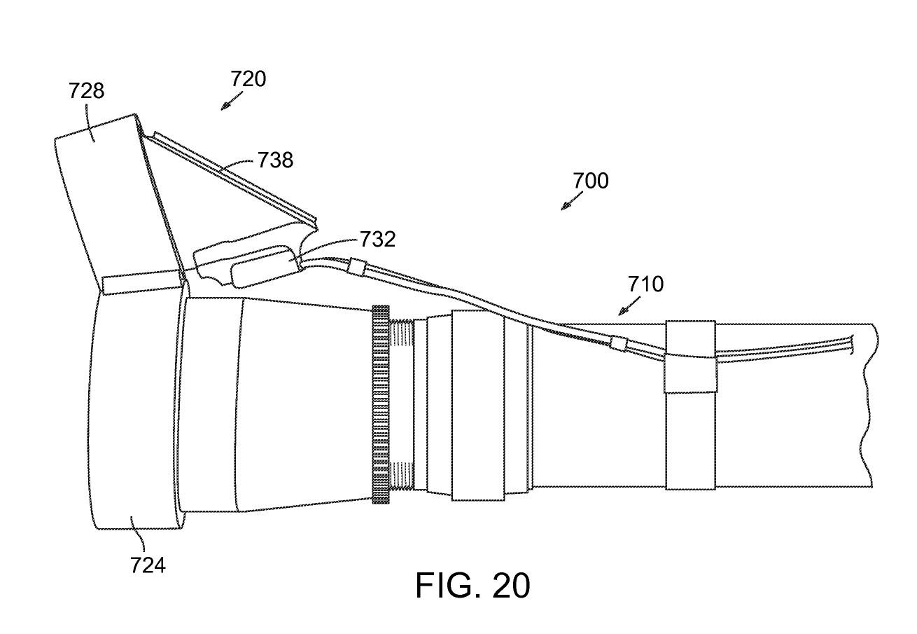

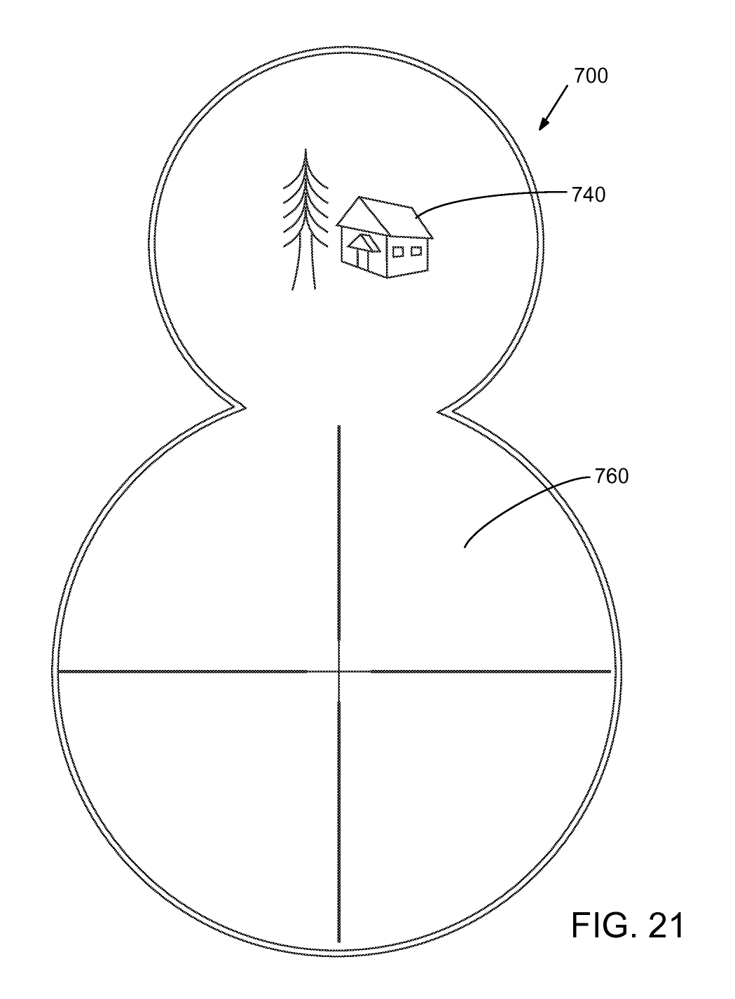

FIGS. 19 and 20 illustrate an optical sighting system 700 including a riflescope 710 and accessory image display device 720 that provides monocular viewing similar to the system 600 of FIG. 17 (in its monocular configuration). In the system 700 of FIGS. 19 and 20, the mount 724 and display housing 728 portions of image display device 720 are formed of a one-piece or monolithic construction and no hinge is provided therebetween. The display housing portion 728 is fixedly angled relative to mount portion 724 to align collimation optics within the display housing portion 728 relative to the optical path of riflescope 710. An OLED micro-display 732 is mounted to an underside of display housing portion 728 where it will be protected from damage, and a mirror 738 reflects light from display 732 through collimation optics (not shown) for viewing from a common eye point (not illustrated) with riflescope 710. FIG. 21 shows a view of system 700 from the common eye point, including a primary direct optical viewing channel 760 of riflescope 710 an a video display channel 740 of accessory image display device 720.

It will be obvious to those having skill in the art that many changes may be made to the details of the above-described embodiments without departing from the underlying principles of the invention. The scope of the present invention should, therefore, be determined only by the following claims.

1. An optical sighting system, comprising:
a first optical system including an objective and an ocular, the first optical system configured to form at a focal plane a first image of a distant target viewable through the ocular from an eye point location along a first optical path;
an accessory device that forms a second image; and
a second optical system cooperating with the accessory device and the first optical system such that the second image is viewable from the eye point location along a second optical path angularly displaced relative to the first optical path.

2. The optical sighting system of claim 1, further comprising an optical combiner positioned in the first optical path between the objective and the ocular, the optical combiner transmitting light from the first optical system and positioned and oriented to reflect light from the second optical system through the ocular.

3. The optical sighting device of claim 2, wherein the optical combiner is selectively switchable between an active condition, extending into the first optical path, and an inactive condition, substantially removed from the first optical path.

4. The optical sighting system of claim 2, wherein:
the ocular has an optical axis; and
the optical combiner includes a partially reflecting surface that is inclined between approximately 30 degrees and approximately 44 degrees relative to the optical axis of the ocular.

5. The optical sighting system of claim 2, wherein:
the ocular has an optical axis; and
the optical combiner includes a partially reflecting surface that is inclined between approximately 46 degrees and approximately 60 degrees relative to the optical axis of the ocular.

6. The optical sighting system of claim 1, further comprising an exterior accessory mount and wherein the accessory device is removably attached to the exterior accessory mount at a fixed position relative to the first optical system.

7. The optical sighting system of claim 1, further comprising an automatic bullet drop compensation device operably coupled to at least one of the first optical system, the accessory device, and the second optical system.

8. The optical sighting system of claim 1, wherein the accessory device includes a device selected from the group consisting of a range finder, a night vision sight, a thermal imaging system, a mapping system, a communication device, and an electronic display device.

9. The optical sighting system of claim 1, wherein the first optical system comprises a riflescope.

10. The optical sighting system of claim 1, further comprising:
a generally tubular housing supporting the first optical system; and
a window located in the housing, the second optical path extending through the window.

11. The optical sighting system of claim 10, wherein a hermetic seal is formed between the window and the housing.

12. The optical sighting system of claim 1, wherein the second image is viewable through the ocular.

13. The optical sighting system of claim 1, further comprising a mirror positioned adjacent a focal plane of the first optical path between the objective and the ocular, the mirror positioned and oriented to reflect light from the second optical system through the ocular.

14. The optical sighting device of claim 13, wherein the mirror is selectively switchable between an active condition and an inactive condition.

15. An optical sighting system, comprising:
a first optical system defining a first optical path;
a second optical system defining a second optical path; and
a shared ocular through which the first and second optical paths extend, the first and second optical systems arranged so that the first and second optical paths are non-coaxial and produce respective first and second viewing channels through the shared ocular, the first and second viewing channels producing offset first and second exit pupils, respectively.

16. The optical sighting system of claim 15, further comprising an optical combiner positioned in the first optical path forward of the shared ocular, the optical combiner transmitting light from the first optical system and arranged to direct light from the second optical system through the shared ocular.

17. The optical sighting system of claim 16, wherein the optical combiner is selectively switchable between an active condition, extending into the first optical path, and an inactive condition, substantially removed from the first optical path.

18. The optical sighting system of claim 15, wherein second optical path is angularly displaced relative to the first optical path as they pass through the shared ocular.

19. The optical sighting system of claim 15, further comprising:
an exterior accessory mount; and
an accessory device removably attached to the exterior accessory mount and cooperating with the second optical system and the shared ocular for generating the second exit pupil.

20. The optical sighting system of claim 15, further comprising an automatic bullet drop compensation device operably coupled to at least one of the first optical system and the second optical system.

21. The optical sighting system of claim 15, wherein the first optical system comprises a riflescope.

22. The optical sighting system of claim 15, further comprising:
an elongate, generally tubular housing supporting the first optical system between opposing first and second ends of the housing; and
a window located in the housing intermediate of the first and second ends, the second optical path extending through the window.

23. A riflescope, comprising:
an elongate housing supporting a primary optical system including objective and ocular lenses positioned proximate respective forward and rearward ends of the housing, the primary optical system defining a primary optical path extending within the housing;
a transparent window formed in a side of the housing intermediate the objective and ocular lenses; and
an optical combiner positioned in the primary optical path adjacent the window and oriented to direct through the ocular lens a plurality of image-carrying light rays entering the housing through the window.

24. The riflescope of claim 23, wherein:
the primary optical system has a first exit pupil viewable through the ocular;
the image-carrying light rays emanate from a second optical system outside the housing that cooperates with the ocular to form a second exit pupil; and
the second optical system and the optical combiner are arranged to direct the image-carrying light rays through the ocular so that the second exit pupil is viewable through the ocular and offset relative to the first exit pupil.

25. The riflescope of claim 23, wherein the optical combiner is selectively removable from the primary optical path.

26. The riflescope of claim 23, further comprising an exterior accessory mount for removably attaching to the riflescope an accessory device for projecting image-carrying light rays through the window.

27. The riflescope of claim 23, wherein a hermetic seal is formed between the window and the housing.

28-30. (canceled)
